(19) United States
(12) Patent Application Publication
(10) Pub. No.: US 2014/0054911 A1
(43) Pub. Date: Feb. 27, 2014

(54) Traffic Barrier Lifter

(71) Applicant: Vacuworx Global, LLC, Tulsa, OK (US)

(72) Inventor: William J. Solomon, Tulsa, OK (US)

(73) Assignee: Vacuworx Global, LLC, Tulsa, OK (US)

(21) Appl. No.: 13/974,559

(22) Filed: Aug. 23, 2013

Related U.S. Application Data
(60) Provisional application No. 61/692,747, filed on Aug. 24, 2012.

(51) Int. Cl. B66C 1/02

(52) U.S. Cl. CPC B66C 1/02
USPC 294/183

(57) ABSTRACT

A traffic barrier lifter having a pair of opposing arms carrying a vacuum pad. An articulating mechanism opens and closes the opposing arms such that the vacuum pads can clamp onto a traffic barrier. Each pad equipped with one or more vacuum reservoirs. These reservoirs are in fluid communication with a vacuum source. The vacuum line running from the reservoir to the vacuum source has a check valve. In the event of a power failure to the vacuum source or failure of the vacuum source itself, the check valve closes to maintain vacuum in the reservoir. The traffic barrier lifter being attachable the boom of an excavator or other appendage of a piece of heavy equipment.

### CROSS-REFERENCE TO RELATED APPLICATIONS

The present application is a conversion and continuation-in-part of U.S. Provisional Patent Application No. 61/692,747 filed on Aug. 24, 2012 which is incorporated herein by reference.

### FIELD OF THE INVENTION

The present invention relates generally to traffic barriers. More particularly, the present invention relates to a device to move traffic barriers.

### BACKGROUND OF THE INVENTION

Traffic barriers, sometimes referred to as Jersey walls, area commonly used to form a temporary wall between two lines of traffic or between a line of traffic and a construction zone. The traffic barriers typically range in length from 10 to 30 feet. They are constricted of steel reinforced concrete and can weigh between 8,000 and 20,000 lbs depending upon their length and cross sectional area. While the exact geometry can vary, they typically have a wide base which narrow towards the top. While some manufactures put an indented trough in the upper portion of the barrier which runs the length of the barrier, many manufactures make all of the upper barrier a continuous flat surface.

Because these traffic barriers are used for temporary protection, they are often moved around a job site and then from job site to job site. As can be imagined moving a 10,000 lb piece of steel reinforced concrete can be challenging. This is especially true on a road construction site where care must be taken so that the barrier or equipment moving the barrier does not accidentally end up in the traffic zone.

The most common practice is to move the barriers using an excavator or frontend loader. This requires a worker to chain the barriers to the bucket of the excavator or frontend loader. An equipment operator can then lift and reposition the barrier with the excavator or frontend loader. This method provides an opportunity for the worker handling the chains to either be hit with a barrier or have one fall on top of him. Both of which can result in serious injury.

What is needed, therefore, is a safe and effective way to move a traffic barrier without having a worker physically attach a chain, cable or sling to the harrier.

### BRIEF DESCRIPTION OF THE INVENTION

The present invention is a traffic barrier lifter having a pair of opposing arms each carrying a vacuum pad. The arms may be pivotal or otherwise articulated to move in a clamping motion relative to one another. The vacuum pads are in fluid communication with a vacuum source and may be in fluid communication with a vacuum reservoir. The arms are operable to enclose two opposing sides of a traffic barrier thus putting the vacuum pads in contact with the traffic barrier. The traffic barrier lifter being attachable the boom of an excavator or other appendage of a piece of heavy equipment.

Additional features may include a rotator. The rotator being capable of rotating the traffic barrier lifter and its load relative to the boom supporting it.

### BRIEF DESCRIPTION OF THE DRAWINGS

Preferred embodiments of the invention will now be described in further detail. Other features, aspects, and advantages of the present invention will become better understood with regard to the following devilled description, appended claims, and accompanying drawings (which are not to scale) where:

FIG. 1 is a perspective view of one embodiment of the traffic barrier mover of the present invention attached to a traffic barrier;

FIG. 2 is a perspective view of a second embodiment of the present invention with an over center hinged mechanism;

FIG. 3 is a piping diagram of the vacuum circuit used in the preferred embodiment of the present invention;

FIG. 4 is the front side of a vacuum pad for the present invention;

FIG. 5 is a front view of the preferred embodiment of the traffic barrier mover of the present invention attached to a traffic barrier;

FIG. 6 is an end view of the preferred embodiment of the traffic barrier mover of the present invention attached to a traffic barrier; and

FIG. 7 is a top view of the preferred embodiment of the traffic barrier mover of the present invention attached to a traffic barrier;

### DETAILED DESCRIPTION OF THE PREFERRED EMBODIMENT(S)

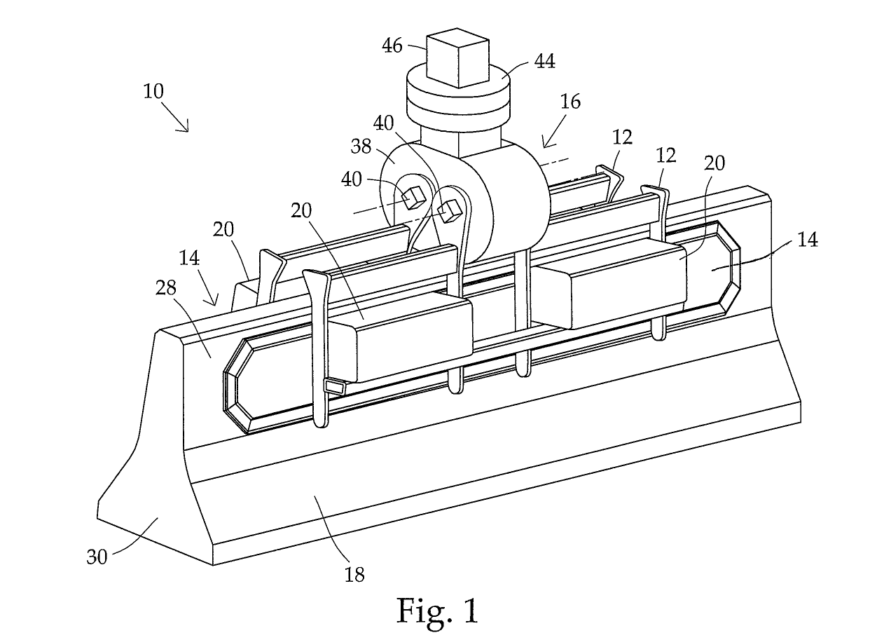

Turning now to the drawings wherein like reference characters indicate like or similar parts throughout. FIG. 1 illustrates a first embodiment of the traffic barrier lifter 10 of the present invention. The lifter 10 has a pair of opposing arms 12 carrying a vacuum pad 14. An articulating mechanism 16 opens and closes the opposing arms 12 such that the vacuum pads 14 can clamp onto a traffic barrier 18.

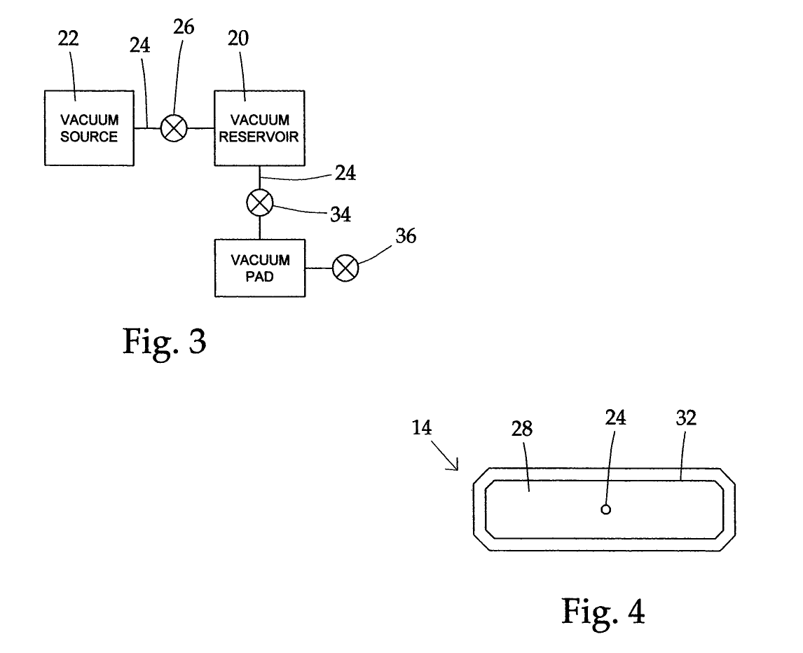

Each pad may be equipped with one or more vacuum reservoirs 20. These reservoirs 20 are in fluid communication with a vacuum source 22. The vacuum line 24 running from the reservoir 20 to the vacuum source 22 has a check valve 26. In the event of a power failure to the vacuum source 22 or failure of the vacuum source 22 itself, the check valve 26 closes to maintain vacuum in the reservoir 20. See FIG. 3. This provides time for the equipment operator to lower the barrier 18 before the vacuum grip on the barrier 18 is dropped.

The vacuum pad 14 has a front side 28 and a backside 30. In the preferred embodiment the vacuum reservoir 20 may be mounted on the backside 30 of the vacuum pad 14 as shown in FIG. 1. In other embodiments they may be remotely mounted. The front side 28 of the vacuum pad 14 preferably has a elastomeric seal 32 extending around the perimeter. See FIG. 4. The seal 32 comes into contact the surface of the barrier 18 and provides a temporary seal between the pad 14 and the barrier 18. Once the seal 32 is in contact with the barrier 18 a valve 34 is opened between the vacuum reservoir and the space created between the front side 28 of the pad 14, the surface of the barrier 18 and the seal 32. This puts the vacuum reservoir 20 and this space in fluid communication and creates a vacuum grip between the pad 14 and the barrier 18. To release this vacuum grip the valve 34 between the vacuum reservoir 20 and this space is closed and a second valve 36 is opened which breaks the vacuum.

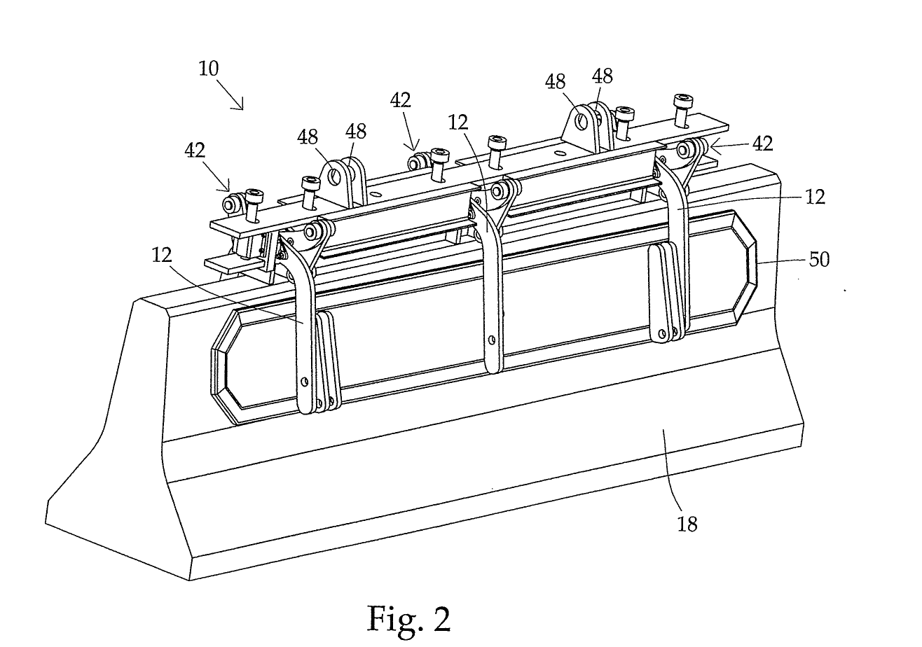

In the preferred embodiment the articulating mechanism 16 is gear drive 38 which rotates both arms 12 about parallel axis 40. Other articulating mechanisms can be used while still falling within the scope of this invention. This includes but is not limited to holding the first arm 12 stationary relative to the lifter 10 while moving the second or opposing arm 12 relative to the first arm 12. It is also possible to use an over center linkage 42 as the articulating mechanism 16 as shown in FIG. 2. The over center linkage 42 increases the force of the arms 12 towards one another as the weight of the barrier 18 being lifted increases.

Other options with the present invention include providing the vacuum grip 44, i.e. the seal 32, valves 34 and 36 and vacuum source, to only one of the pads 14. Thus only a single vacuum pad 14 would pull suction on the barrier 18.

Yet another option is to provide a rotator 44 attached to the gear drive 38. The lifter 10 would then be mounted to the boom 46 of an excavator or backhoe. The rotator 44 would preferably be hydraulically powered, however other means of power known in the industry could also be used. The rotator 44 rotates the lifter 10 relative to the boom 46. Additionally the lifter 10 could be mounted on a frontend loader either with or without the rotator 44.

FIG. 2 shows a perspective view of another embodiment of the lifter 10 of the present invention. This embodiment utilizes an over center linkages 40, discussed above to articulate the vacuum pads 14. This embodiment of the lifter 10 can be mounted to a vacuum lifter beam, such as a VACUWORX ® RC10, via the lugs 48. The vacuum lifter beam would provide a suction source and vacuum reservoir to the pads 50 via a vacuum line. Hydraulic power from the excavator or external power pack would power the over center linkage 40.

Other configurations of the present invention include but are not limited to mounting the vacuum source 22 on an outrigger on the back of the excavator such that it works as a counter weight to the boom 46. Likewise the vacuum reservoir 20 and/or a hydraulic power supply could also he mounted on an outrigger on the back of the excavator. Vacuum and/or hydraulic power would then be supplied to the lifter 10 via suitable piping and tubes.

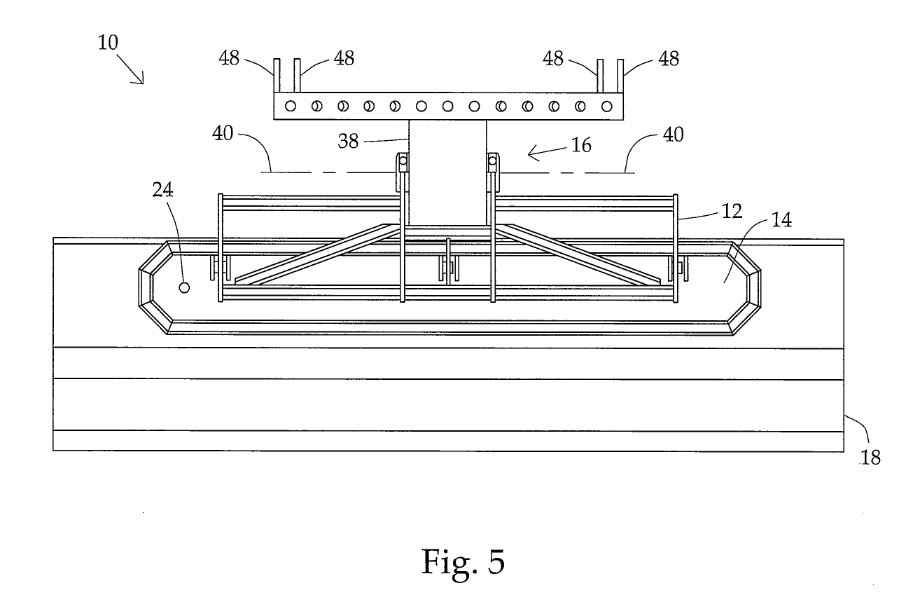

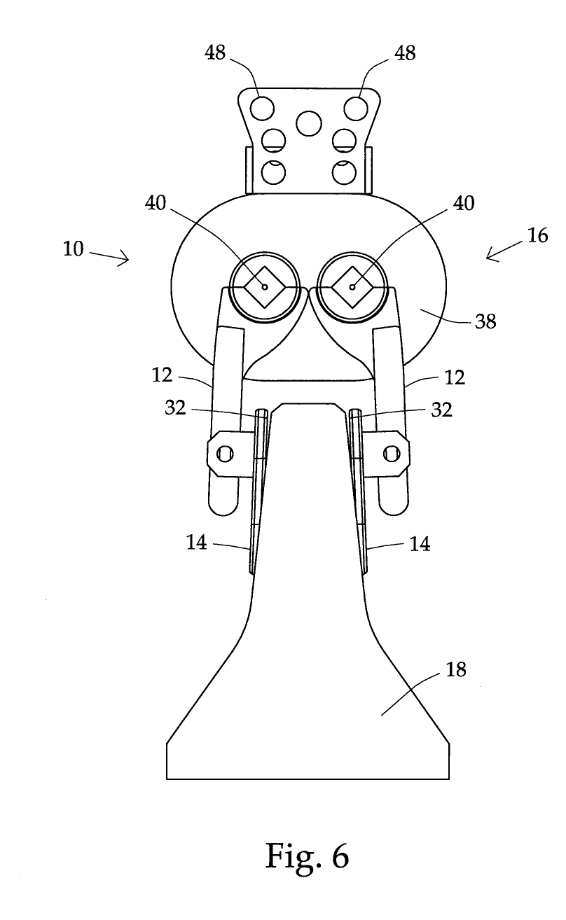

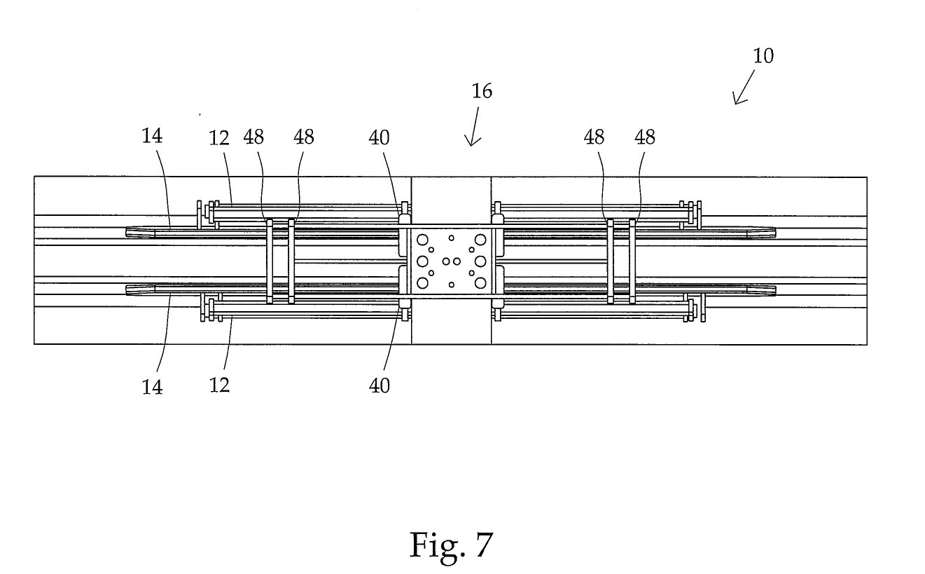

FIGS. 5, 6 and 7 show the preferred embodiment of the lifter 10 holding a traffic barrier 18. It has a gear drive 38 as the articulating mechanism 16. A pair of arms 12 each are attached to a vacuum pad 14. The vacuum pads 14 are constructed as shown in FIG. 4 The arms 12 are also pivotally attached the gear drive 38 and pivot relative to the gear drive 38 on two parallel axis 40. The pneumatic circuit for the lifter 10 are the same as that shown in FIG. 3.

The lifter 10 of FIGS. 5 through 7 has plurality of lugs 48 connected to the gear drive 38. The lugs 48 can be used to secure the lifter 10 to a vacuum lifter beam, such as a VACUWORX ® RC10, or similarly designed vacuum lifter beam. The vacuum lifter beam would provide a suction source and vacuum reservoir to the pads 14 via a vacuum line 24. It would be used in conjunction with an excavator or other machinery with boom 46. Hydraulic power from the excavator or external power pack would power the gear drive 38.

In the embodiment shown in FIGS. 5-7, a rotator 44 may be located between the boom 46 and the vacuum lifter beam. The rotator 44 would be able to rotate the vacuum lifter beam, lifter 10 and traffic barrier 18 relative to the boom 46. Hydraulic power from the excavator or external power pack would power the rotator 44.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the fall range of equivalency to which each element thereof is entitled.

What is claimed is:

1. A traffic barrier lifter for use on a boom, said lifter comprising:
an articulating mechanism; and
a pair of opposing arms each having a vacuum pad, the arms being mounted to the articulating mechanism;
wherein the articulating mechanism is capable of moving the pair of opposing arms from an open position to a closed position; and the vacuum pads being in fluid communication with a vacuum source and a valve capable of opening to atmosphere.

2. A device according to claim 1 further comprising:
a rotator capable of rotating the lifter relative to the boom.

3. A device according to claim 1, further comprising:
a vacuum reservoir in fluid communication with the vacuum pad and the vacuum source.

4. A device according to claim 3, further comprising:
the vacuum reservoir being mounted on the arm.

5. A device according to claim 3, further comprising:
a check valve in fluid communication with the vacuum source and the vacuum reservoir and located between the vacuum source and the vacuum reservoir.

6. A device according to claim 1, said vacuum pad comprising:
a flat surface with a elastomeric seal along the periphery of the surface, and
a vacuum line providing fluid communication with a vacuum reservoir.

7. A device according to claim 1, said articulating mechanism comprising:
a gear drive having one or more rotating axis.

8. A device according to claim 1, said articulating mechanism comprising:
a pair of rotating parallel axis.

9. A device according to claim 1, said articulating mechanism comprising:
two or more over center linkages.

10. A traffic barrier lifter for use on a boom, said lifter comprising:
an articulating mechanism having a gear drive with two parallel axis of rotation;
a pair of opposing arms each having a vacuum pad, the arms being mounted on the articulating mechanism;
each vacuum pad having a flat surface with a elastomeric seal along the periphery of the surface, and a vacuum line providing fluid communication with a vacuum reservoir and a vacuum source; and
a rotator capable of rotating the lifter relative to the boom;
wherein the articulating mechanism has is capable of moving the pair of opposing arms from an open position to a closed position and the vacuum pads being in fluid communication with a vacuum source and a valve capable of opening to atmosphere.
